(19) United States
(12) Patent Application Publication
(10) Pub. No.: US 2018/0260778 A1
(43) Pub. Date: Sep. 13, 2018

(54) SELF DRIVING AUTOMATED VENDING VEHICLE

(71) Applicant: Wheely's Café International AB, Varmdo (SE)

(72) Inventors: Tomas MAZETTI, Varmdo (SE); Hannah MAZETTI, Varmdo (SE)

(21) Appl. No.: 15/453,116

(22) Filed: Mar. 8, 2017

(51) Int. Cl. G06Q 10/08; G06Q 30/02; G05D 1/00; G01C 21/20

(52) U.S. Cl. CPC G06Q 10/0875; G06Q 30/0202; G05D 2201/0216; G01C 21/206; G05D 1/0088

(57) ABSTRACT

Methods and devises for controlling stocking of items within an autonomous vending vehicle and routing of the same. A method includes, for example, detecting S100 removal of at least one item from the vending vehicle, registering S110 vending parameters including at least type of the removed at least one item and position data of the vending vehicle, sending S300 request for a low stock item to a server 30 when the amount of the at least one item is below a predetermined threshold value, wherein the request comprises type of item and position of the vending vehicle and receiving S500 routing and stocking instructions from the server based on the sent request.

### TECHNICAL FIELD

The present disclosure relates to the field of controlling stocking of items within an autonomous vending vehicle and routing of the same and to an autonomous vending vehicle.

### BACKGROUND

Autonomous vehicles that are capable of operation without human interactions are rapidly developing. Such vehicles are developed to improve local transportation by providing improved functionality and allowing methods and systems to be utilized for moving passengers and items. It is known to control self-driving vehicles to drive and pick up passengers or packages at specific destinations based on demands from passengers or delivery information of parcels. To increase the usefulness of autonomous vehicles, there is a need for increased functionality.

### SUMMARY

This disclosure provides improved methods for controlling stocking of items within an autonomous vending vehicle and routing of the same, for controlling at least one autonomous vending vehicle and an autonomous vending vehicle.

With the above background in mind, then, an aspect of the present disclosure is to provide methods and an autonomous vending vehicle, which seeks to mitigate, alleviate, or eliminate one or more of the above-identified deficiencies in the art and disadvantages singly or in any combination.

According to some aspects of the disclosure, it provides for a method for controlling stocking of items within an autonomous vending vehicle and routing of the same. The method comprises detecting removal of at least one item from the vending vehicle, registering vending parameters comprising at least type of the removed at least one item and position data of the vending vehicle, sending request for a low stock item to a server when the amount of the at least one item is below a predetermined threshold value, wherein the request comprises type of item and position of the vending vehicle and receiving routing and stocking instructions from the server based on the sent request. Thus, the autonomous vending vehicle is automatically re-stocked when running low on individual items. In other words, an autonomous vending vehicle is provided that takes its own inventory and requests to re-stock.

According to some aspects, the routing and stocking instructions comprises routing instructions to a geographical location to converge with a further autonomous vending vehicle and stocking instructions to receive the at least one item from the further autonomous vending vehicle. In other words, the autonomous vending vehicle is instructed to go to a specific geographical location to be re-stocked by another autonomous vending vehicle. In other words, the autonomous vending vehicle is re-stocked without going to a specific warehouse. This can save a lot of time and fuel by not having to drive the autonomous vending vehicle to a fixed location of a warehouse. The two autonomous vending vehicles are routed to a geographical location that is optimal considering the driving path of both vehicles.

According to some aspects, the method comprises docking with a further vending vehicle at the geographical location based on the routing and stocking instructions to receive the at least one item. Thus, the autonomous vending vehicle is automatically re-stocked without having to go to a fixed location of, for example, a warehouse.

According to some aspects, the vending parameters further comprises time data indicating when the at least one item was removed. By having a time indication of removal, or in other words, sales of a specific item, a history log can be created and thus predictions of future sales can be made.

According to some aspects, the method comprises updating an item list of the vending vehicle based on the at least one removed item. An item list of the vending vehicle is an efficient way of keeping track of the items in an autonomous vending vehicle.

According to some aspects, the item list is updated with the vending parameters. The item list can thus be used to predict future sales by using statistics to determine probable future sales at specific locations.

According to some aspects, the routing and stocking instructions are automated and based on registered vending parameters and current position of the vending vehicle. In other words the routing and stocking instructions are based on historical sales of the vehicle and of current position. The system can therefore predict future probable sales and stock accordingly.

According to some aspects, the method comprises receiving a request for a specific item from server and sending stock information comprising the amount of the requested item within the vending vehicle and position of vending vehicle to server. An advantage of this is that the server can keep track of the stock of all autonomous vending vehicles. The server can then determine which vehicles to route to re-stock each other.

According to some aspects, the method comprises receiving pricing instructions, which are based on registered vending parameters and current location of vending vehicle from the server and updating price of items based on received pricing instructions. In other words, the pricing of an item may be different at different locations and/or at different times. For example, if an item is very popular at a specific geographical location, the pricing may be set higher at that specific location and thus allowing for increased profit for that item.

According to some aspects, the method comprises initiating a transaction of items by registering an entrance of a customer to the vending vehicle and registering a customer profile, wherein the profile comprises information regarding at least an account for payment and detecting exit of a customer from the vending vehicle and charging the customer account for payment for removal of the at least one item. So a customer enters the autonomous vending vehicle, receives at least one item and upon exit is charged for the item. This is an efficient way of selling items to customers at un-fixed locations.

According to some aspects, the method comprises receiving routing instructions based on any one of registered vending parameters, time, date and position parameters of the vending vehicle.

According to some aspects, the method comprises receiving a request from server to supply a further autonomous vending vehicle with specific item. In other words, the autonomous vending vehicle may be requested to stock other vending vehicles as well.

According to some aspects of the disclosure, it provides for a method for controlling at least one autonomous vending vehicle. The method comprises logging a demand for specific sales items from customers, wherein the logged demand comprises a sales history of sold items and geographical location information, routing the vending vehicle to a geographical location based on the logged demand and automatically stocking the vending vehicle with at least one sales item based on the logged demand. The advantage with this is that autonomous vending vehicles may be routed based on sales history to go to geographical locations where it is determined to be the most sales opportunities. In other words, the autonomous vending vehicles will be routed to where the demand of the items it is carrying is high. Thus, a sales efficient route is created for the vehicle.

According to some aspects, the method comprises calculating the probability of sales of a specific item at a geographical location based on the logged demand. In other words, the sales history of the autonomous vending vehicle, or of other autonomous vending vehicles, or a combination thereof, is used to determine the route of the vehicle to increase sales.

According to some aspects, the stocking comprises routing the vending vehicle to a warehouse for receiving at least one sales item. According to some aspects, the stocking comprises routing the vending vehicle to a further vending vehicle for receiving at least one sales item. In other words, the automatic vending vehicle may either be routed to a warehouse for stocking an item or to converge with another vending vehicle for stocking. The decision of where to route is based on efficiency, either financial or timewise.

According to some aspects of the disclosure, it provides for an autonomous vending vehicle for controlling stocking of items and routing of the same. The autonomous vending vehicle comprises a control unit configured to detect removal of at least one item from the vending vehicle, register vending parameters comprising at least type of the removed at least one item and position data of the vending vehicle, send request for a low stock item to a server when the amount of the at least one item is below a predetermined threshold value, wherein the request comprises type of item and position of the vending vehicle; and receive routing and stocking instructions from the server based on the sent request.

According to some aspects of the disclosure, it provides for an autonomous vending vehicle. The autonomous vending vehicle comprises a control unit configured to log a demand for specific sales items from customers, wherein the logged demand comprises a sales history of sold items and geographical location information, route the vending vehicle to a geographical location based on the logged demand and automatically stock the vending vehicle with at least one sales item based on the logged demand.

The advantages with the autonomous vending vehicles have been previously discussed.

### BRIEF DESCRIPTION OF THE DRAWINGS

The present technique will be more readily understood through the study of the following detailed description of the aspects together with the accompanying drawings, of which:

FIG. 1 shows an overview of the shopping process according to an embodiment of the present invention.

FIG. 2 shows an overview of the routing and stocking process according to an embodiment of the present invention.

FIG. 3 illustrates a block diagram according to some aspects of the disclosure.

FIG. 4 illustrates a block diagram according to some aspects of the disclosure.

FIG. 5 illustrates a block diagram of an autonomous vending vehicle according to some aspects.

It should be added that the following description of the embodiments is for illustration purposes only and should not be interpreted as limiting the disclosure exclusively to these embodiments/aspects.

### DETAILED DESCRIPTION

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Aspects of the disclosure are described with reference to the drawings, e.g., block diagrams and/or flowcharts. The numbers in the drawings refer to corresponding elements throughout.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

Various embodiments of methods and vehicles for controlling stocking of items within an autonomous or self-driving vending vehicle and routing of the same are disclosed. As used herein, the terms “autonomous” and “self-driving” and variants thereof when used in describing a vehicle refer to a vehicle designed to perform all diving functions of a vehicle, including safety-critical driving functions and monitor roadway conditions.

The term “converge” in this disclosure is defined as to come together. I.e. those two transports converge means that they meet up at a geographical location.

This disclosure provides improved methods and autonomous vehicles for controlling a system of autonomous vending vehicles, also called mobile supermarkets on wheels or mobile sales units (MSU), which, according to some aspects, automatically stocks itself with items or goods and moves where the demand is, or where it is ordered by consumers. In other word “The store that comes to you, instead of you coming to the store”.

According to some aspects of the disclosure, the system lets the end users, the consumers, take their products or items and be charged without any staff interaction, or cash being transferred. They enter the store, i.e. the autonomous ending vehicle, take what they want and when they leave, their account is charged.

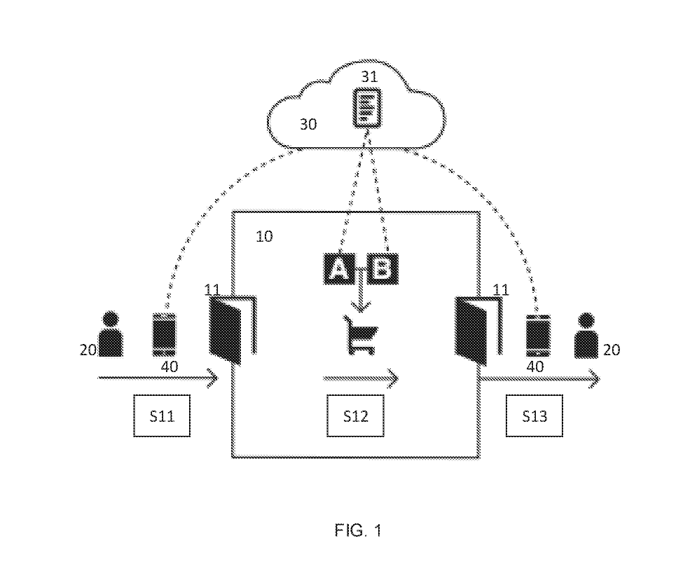

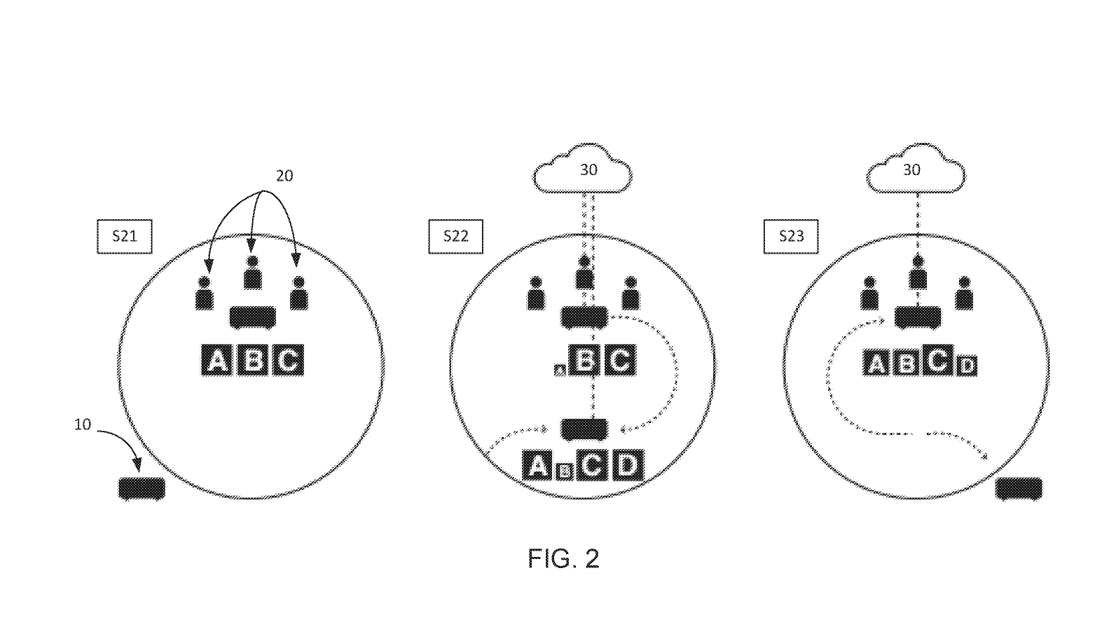

FIGS. 1 and 2 provides an explanation of the different illustrations used in the description. The square boxes with A, B, C and D in them are types of physical objects, goods or items, to be transported and/or sold. The cloud 30 illustrates the computing cloud, i.e. the cloud for internet based computing. The cloud has been implemented in a server but can also be more than one servers working together. The truck symbolizes an autonomous vending vehicle 10 and can take many forms; such as a truck, a car, a ship, a boat, a bicycle, a motorbike or an airplane. The person-shaped illustrations represent customers 20. The rectangular shape with a door represents a warehouse/store 11 within the vending vehicle 10.

FIG. 1 illustrates an example of the present disclosure. A client 20, or customer, enters S11 a door 11 of the autonomous vending vehicle 10, adds S12 sales items A and B to a shopping cart, or simply picks the items up, and then leaves S13 the autonomous vending vehicle. In this example of use, the customer 20 carries a smart phone 40 which is detected upon entrance of the autonomous vending vehicle. The smart phone can communicate directly with the autonomous vending vehicle so that the client is charged for her/his items upon exit.

An example of use when a client has pre-ordered her/his items is as follows. The purchases are done by a physical person 20 using a mobile device 40, in-place ordering systems or similar solutions. The purchase is sent to a server system that receives purchaser information including identification of the purchaser, payment information, and shipment information from the client system. The server system then assigns a purchase identifier to the client system and associates the assigned client identifier with the received purchaser information. The client system receives and stores the assigned purchase identifier and enables an order button. In response to the selection of the order button, the client system sends to the server system a request to purchase the identified item. The server system receives the request and combines the purchaser information associated with the client identifier of the client system to generate an order to purchase the item in accordance with the billing and shipment information whereby the purchaser affects the ordering of the product by selection of the order button. The client then picks up the products at the autonomous vending vehicle and is charged upon exit. The autonomous vending vehicle has then been stocked in advance according to the order.

FIG. 2 illustrates an example a method for dispatching, routing, stocking, re-stocking and otherwise controlling a number of self-driving, vending vehicles or mobile store units, MSU, as well as allowing the purchase, sales and ordering of goods or items without cash or human interaction. The stores will use prediction and learned customer data to provide bespoke experience for customers. The autonomous vending vehicles move around depending on demand, and re-stock themselves, when necessary with the goods necessary or indicated. The autonomous vending vehicles may carry both products of a traditional supermarket, but also products especially for the local demographics, as well as deliver ordered products. This way a number of relatively smaller autonomous vending vehicles can replace bigger stores.

FIG. 2 illustrates an example of stocking of items in an autonomous vending vehicle. The vehicle in the circle S21 has items of type A, B and C stocked, but after having had several customers, item A is running low. Another autonomous vending vehicle is then directed to the location S22. The other autonomous vending vehicle has items of type A, B, C and D stocked but is running low on B. When converging, other autonomous vending vehicle hands over items of type A and D and receives items of type B. So that when the other autonomous vending vehicle is leaving, both autonomous vending vehicles have all types of items in stock.

A more specific example is as follows: step S21: Based on demographics, the autonomous vending vehicle 10 is at a position selling chocolates A-C. Step S22: After 5 hours the vehicle needs to re-stock product A. The cloud 30, or server, calculates the best time and place to do this at 4 a.m. At that time, the autonomous vending vehicle converges with another autonomous vending vehicle to re-stock. It also adds a few of chocolate D. Step S23: After some time, it can compare sales of chocolate A-D and re-stock accordingly.

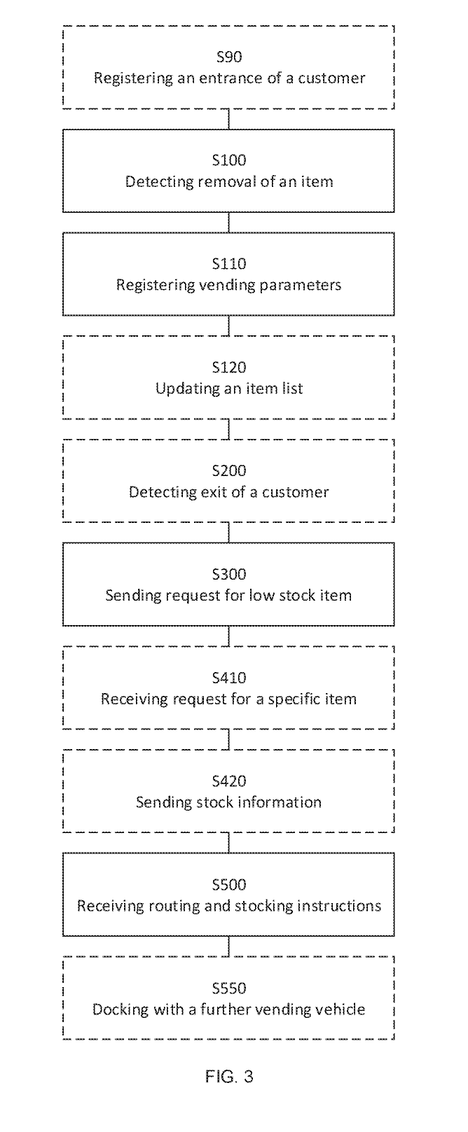

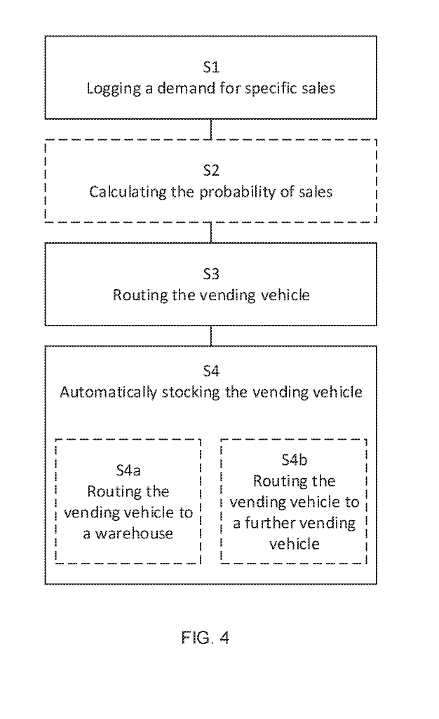

FIGS. 3 and 4 illustrate block diagrams of examples of the methods. It should be noted that the blocks with a solid line are part of the method in the broadest example implementation of the disclosure. The boxes with dotted lines are example aspects. The boxes are not necessarily performed in the illustrated order.

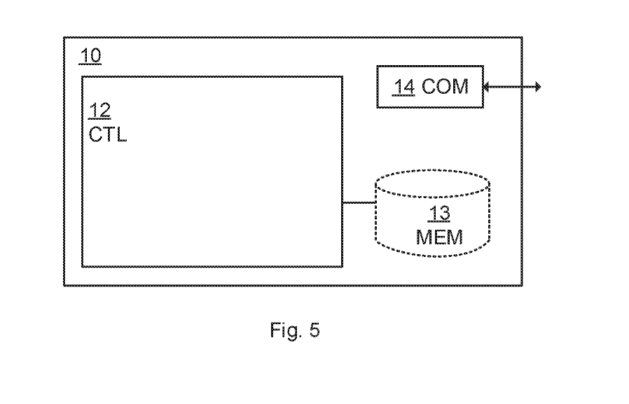

The disclosure provides for a method for controlling stocking of items within an autonomous vending vehicle 10 and routing of the same. The autonomous vending vehicle 10 is illustrated in FIG. 5 and comprises a control unit 12 configured to perform the method of the disclosure. The autonomous vending vehicle further comprises communication means 14 arranged to communicate wirelessly with a server. The communication means is communication circuitry that can communicate wirelessly, for example via 2G, 3G, 4G or 5G. The autonomous vending vehicle may further comprise a local memory 13 for storing information discussed below. The memory may also be a remote memory which is in communication with the autonomous vending vehicle via the communication circuitry,

Controlling stocking of items here means controlling the inventory of items in the autonomous vending vehicle; in other words controlling the number of items of specific types in the autonomous vending vehicle. The method comprises detecting S100 removal of at least one item from the vending vehicle, as shown in FIG. 3. The item has for example been purchased by a customer. The detecting is done for example by having sensors on the shelf where the items are located in the vehicle and when the item is removed from the shelf, the sensor detects the removal. Another example of detecting removal is to use barcodes on the items that the customers register when removing them. Instead of barcodes, for example NFC, Near Field Communication, tags or QR, Quick Response, codes may be used which are registered using the customers smart phone or a reader provided in the vehicle. Another example of detecting removal is if the autonomous vending vehicle is designed to have locked boxes which are accessed from the outside of the autonomous vending vehicle. In such a case, the customer may for example pre-order her/his items beforehand using a computer or a smart phone, or the customer may indicate her/his desired items on a panel of the vending vehicle. The item or items are then moved inside the vehicle to the box so that they are accessible for the customer. According to some aspects, a door to the box remains locked until the customer has registered a payment for the item(s).

Vending parameters are then registered S110. Registering vending parameters comprises for example to store the information in the memory. The vending parameters comprises at least: type of the removed at least one item and position data of the vending vehicle. In other words, the vending parameters comprise what item or items have been removed and the position of the autonomous vending vehicle when they were removed. The autonomous vending vehicle then sends S300 a request for a low stock item to a server 30 when the amount of the at least one item is below a predetermined threshold value. The predetermined threshold is for example set based on the popularity of the item. A popular item has a higher threshold value than a less popular one. An item that is very rarely sold might for example have 0 as threshold value, so that the item is not re-stocked until it is completely sold out. A very popular item may have 100 as a threshold value because it may only take a couple of hours for the vehicle to sell out a hundred items of that type. Hence, there is no need for the autonomous vending vehicle to have an excessive amount of unpopular items in stock. In other words, low stock is here used as an indication that an item may sell out imminently. In other words, a low stock item is an item where the amount of the item is below a predetermined threshold value.

The request for a low stock item comprises type of item and position of the vending vehicle. The type of item is necessary information for the request since otherwise the server cannot know what items are needed in the requesting vehicle. The position of the autonomous vending vehicle is used to determine where the re-stocking of the item should take place. The position of the autonomous vehicle may be continuously sent to the server by the vehicle. The position is for example determined by using a GPS in the vehicle.

The autonomous vending vehicle receives S500 routing and stocking instructions from the server based on the sent request. Thus, the autonomous vending vehicle is automatically re-stocked when running low on individual items. In other words, an autonomous vending vehicle is provided that takes its own inventory and requests to re-stock.

In other words, the autonomous vending vehicle is a mobile sales unit with no staff. Items are for example goods, food, packets or mail. The type of the removed at least one item is for example chocolate, coca cola, milk, letter, package etc.

According to some aspects, the routing and stocking instructions comprises routing instructions to a geographical location to converge with a further autonomous vending vehicle and stocking instructions to receive the at least one item from the further autonomous vending vehicle. In other words, the autonomous vending vehicle is instructed to go to a specific geographical location to be re-stocked by another autonomous vending vehicle. In other words, the autonomous vending vehicle is re-stocked without going to a specific warehouse. This can save a lot of time and fuel by not having to drive the autonomous vending vehicle to a fixed location of a warehouse. The two autonomous vending vehicles are routed to a geographical location that is optimal considering the driving path of both vehicles. According to some aspects the autonomous vending vehicle is instructed to stay in position and await another autonomous vending vehicle for re-stocking. It might be the case that the autonomous vending vehicle is in such a good selling position that it is more beneficial for another autonomous vending vehicle to come with items that are running low in the vehicle. The geographical location is an unfixed location where the transports can converge. Another word for the geographical location is switch point, or movable switch point, since the location is not based on the location of for example a warehouse or the like but is just a location where two, or more, autonomous vending vehicles converges to directly hand over one or more items. Another word for the geographical location is a converging place, i.e. a place where the vehicles converges. In other words, the geographical location is a location where it is suitable for two or more vehicles to meet, both space wise and route wise for both vehicles.

The method comprises, according to some aspects, docking S550 with a further vending vehicle at the geographical location based on the routing and stocking instructions to receive the at least one item. Thus, the autonomous vending vehicle is automatically re-stocked without having to go to a fixed location of, for example, a warehouse. The docking comprises for example that the two autonomous vending vehicles mechanically connect to each other and the at least one item is moved from one autonomous vending vehicle to the other by a robotic arm. Another example is that the item is moved from one autonomous vending vehicle to the other via a conveyor belt that is directed from the giving autonomous vending vehicle to a receiving opening in the receiving autonomous vending vehicle. The docking may be conducted in many different ways and the requirement for the docking is that it enables one autonomous vending vehicle to hand over an item to another autonomous vending vehicle.

The vending parameters further comprises, according to some aspects, time data indicating when the at least one item was removed. By having a time indication of removal, or in other words, sales of a specific item, a history log can be created and thus predictions of future sales can be made. To be able to predict a future demand, information regarding the sales is stored. The information can be used to determine geographical locations for likely sales of specific items.

According to some aspects, the method comprises updating S120 an item list of the vending vehicle based on the at least one removed item. An item list of the vending vehicle is an efficient way of keeping track of the items in an autonomous vending vehicle. By checking the item list, the autonomous vending vehicle can keep track of what items are running low, for example by comparing them to a list of threshold values for each specific item.

The item list is for example updated with the vending parameters. The item list can thus be used to predict future sales by using statistics to determine probable future sales at specific locations and at specific times of the day.

The routing and stocking instructions are, according to some aspects, automated and based on registered vending parameters and current position of the vending vehicle. In other words the routing and stocking instructions are based on historical sales of the vehicle and of current position. The system can therefore predict future probable sales and stock accordingly. The system also predicts at what time a day and on what days it is most beneficial for the autonomous vending vehicle to be at certain geographical locations. It may for example be determined that on Saturdays at lunch time many customers usually buy salads and sodas at a specific location. The autonomous vending vehicle is then stocked accordingly and is routed to that location at lunch time on Saturdays. Thus the autonomous vending vehicles are stocked and routed according to historical demand of items. The demand is thus predicted using past sales. In other words, the autonomous vending vehicles are automatically stocked of items and routed to areas depending on demand, demographics and experience in relation to purchase.

The autonomous vending vehicle may be used to re-stock other autonomous vending vehicles. Therefore, according to some aspects, the method comprises receiving S410 a request for a specific item from server 30 and sending S420 stock information comprising the amount of the requested item within the vending vehicle and position of vending vehicle to server 30. An advantage of this is that the server can keep track of the stock of all autonomous vending vehicles. The server can then determine which vehicles to route to re-stock each other. As previously discussed, the autonomous vending vehicles may continuously send their position to the server. The autonomous vending vehicles may also continuously send information regarding its items to the server or to send an updated inventory list to the server every time it changes due to a purchase or a hand over to another vehicle.

According to some aspects, the method comprises receiving pricing instructions, which are based on registered vending parameters and current location of vending vehicle from the server 30 and updating price of items based on received pricing instructions. In other words, the pricing of an item may be different at different locations and/or at different times. For example, if an item is very popular at a specific geographical location, the pricing may be set higher at that specific location and thus allowing for increased profit for that item. Thus, the pricing is set automatically, in real time and depending on area and demand.

One way of performing the purchase of a customer comprises initiating a transaction of items by registering an entrance S90 of a customer to the vending vehicle and registering a customer profile, wherein the profile comprises information regarding at least an account for payment and detecting S200 exit of a customer from the vending vehicle and charging the customer account for payment for removal of the at least one item. For example, a customer registers using her/his credit card or bank account card and opens a door on the autonomous vending vehicle. The customer receives one or several items from the vehicle and upon exit is charged for the item. This is an efficient way of selling items to customers at un-fixed locations. The customer can according to some aspects pre-order the items so that she/he has already payed when entering the vehicle or the items are already prepared inside the vehicle according to the order when the customer enters. According to some aspects, the customer does not have to enter the autonomous vending vehicle but can access the stocked items from outside via for example a touch panel. The customer may then enter the desired items and they are then automatically moved to an exit chamber in the vehicle that the customer can access when she/he has paid for the items.

According to some aspects, the method comprises receiving routing instructions based on any one of: registered vending parameters, time, date and position parameters of the vending vehicle. The automatic stocking of automatic vending vehicles thus depends on areas, demand, demographics, experience in relation to selling of goods.

According to some aspects the routing instructions are based on traffic situation, such as instructions to avoid traffic jams or traffic accidents or the like.

The method comprises, according to some aspects receiving S600 a request from server to supply a further autonomous vending vehicle with specific item. In other words, the autonomous vending vehicle may be requested to stock other vending vehicles as well. This has been previously discussed.

A method for stocking based on demand is provided. The method is illustrated in FIG. 4. The disclosure provides a method for controlling at least one autonomous vending vehicle 10. As previously described, the autonomous vending vehicle 10 is illustrated in FIG. 5 and comprises a control unit 12 configured to perform the method of the disclosure. The autonomous vending vehicle further comprises communication means 14 arranged to communicate wirelessly with a server. The communication means is communication circuitry that can communicate wirelessly, for example via 2G, 3G, 4G or 5G. The autonomous vending vehicle may further comprise a local memory 13 for storing information discussed below. The memory may also be a remote memory which is in communication with the autonomous vending vehicle via the communication circuitry. The method comprises logging S1 a demand for specific sales items from customers, wherein the logged demand comprises a sales history of sold items and geographical location information. The sales history comprises for example type of item, price of item, location of the sales and time of sales. The method further discloses routing S3 the vending vehicle to a geographical location based on the logged demand and automatically stocking S4 the vending vehicle with at least one sales item based on the logged demand. The advantage with this is that autonomous vending vehicles may be routed based on sales history to go to geographical locations where it is determined to be the most sales opportunities. In other words, the autonomous vending vehicles will be routed to where the demand of the items it is carrying is high. Thus, a sales efficient route is created for the vehicle. The routing and stocking has been previously discussed.

According to some aspects, the method comprises calculating S2 the probability of sales of a specific item at a geographical location based on the logged demand. In other words, the sales history of the autonomous vending vehicle, or of other autonomous vending vehicles, or a combination thereof, is used to determine the route of the vehicle to increase sales. The probability of sales of a specific item at a specific location may be calculated as the number of times the vehicle has sold the item at the location divided by the total number of times that the autonomous vending vehicle has been to the location. The number of sold items may be taken into account as well as time of day and/or the date of sales.

In some cases, it might be more time efficient to re-stock at a warehouse than by another autonomous vending vehicle. Therefore, according to some aspects, the stocking S4 comprises routing S4a the vending vehicle to a warehouse for receiving at least one sales item. According to some aspects, the stocking S4 comprises routing S4b the vending vehicle to a further vending vehicle for receiving at least one sales item. In other words, the automatic vending vehicle may either be routed to a warehouse for stocking an item or to converge with another vending vehicle for stocking. The decision of where to route is based on efficiency, either financial wise or timewise.

According to some aspects of the disclosure, it provides for an autonomous vending vehicle for controlling stocking of items and routing of the same. The autonomous vending vehicle comprises a control unit configured to detect S100 removal of at least one item from the vending vehicle, register S110 vending parameters comprising at least type of the removed at least one item and position data of the vending vehicle, send S300 request for a low stock item to a server 30 when the amount of the at least one item is below a predetermined threshold value, wherein the request comprises type of item and position of the vending vehicle; and receive S500 routing and stocking instructions from the server based on the sent request.

According to some aspects of the disclosure, it provides for an autonomous vending vehicle. The autonomous vending vehicle comprises a control unit configured to log S1 a demand for specific sales items from customers, wherein the logged demand comprises a sales history of sold items and geographical location information, route S3 the vending vehicle to a geographical location based on the logged demand and automatically stock S4 the vending vehicle with at least one sales item based on the logged demand.

Several examples of use of the methods of the disclosure are as follows.

The automatic vending vehicles are aware of the amount of registered clients in an area. In other words, in this example, clients have registered for use of the autonomous vending vehicles. Or the amount of potential clients may be based on registered sales history. When there are numerous potential clients in an area, a mobile store unit, MSN, i.e. an autonomous vending vehicle, can be dispatched to that area, with the products that the data on the client's shopping behaviour predict will be purchased. This way, the risk of overstocking is minimised, and the vehicles are automatically moved from non-profitable locations.

The store, i.e. the autonomous vending vehicle, fills itself, i.e. stocks itself, depending on demand. If a certain vehicle at location X regularly runs out of product Y, then more of that product will automatically be stored.

At the same moment as the purchase is completed, the database may be updated, and a request for re-stocking of the items sold is made. The system also gets data of who bought what goods, and can thereby re-stock these items in preparation for the next time the autonomous vending vehicle is in the area.

The autonomous vending vehicles are for example directed to places automatically, depending on demographic data, as well as try outs. A vehicle might be placed at a certain spot in a certain village for a while, and then change spot to see what works well. This way statistical data is gathered over time to determine what geographical locations are profitable at what times of day. A vehicle may be moving between villages or cities, thereby serving a number of communities at different times.

It should be noted that any automatic vending vehicle can also serve as the address for a parcel or other goods. This is valuable in places where people do not have fixed addresses, or simply want to pick up their things somewhere else than home.

Each person has their own individual shopping habits, as well as dreams. We purchase a certain Cereal, or a certain Whiskey. We dream of a certain kind of food. We are more or less inclined to swap from one brand or one product to another. The automatic vending vehicles gathers sales data from people and send it to the cloud, i.e. one or more servers, where it can be used to stock the vehicles both at a community level (people drink milk) and at an individual level (you drink a certain milk brand) or at a global level (people of certain shopping patterns buy certain products or brands).

If you are a registered user of the automatic vending vehicles, the system know what you buy, and where you live at the moment, meaning that, if you move to another village, the vending vehicle at the your new location will be updated with your regular purchases. In one example the item list connected to you will be updated with your new location and the vending vehicle at you new location will receive your item list and thus will be updated with your regular purchases.

The restocking of the autonomous vending vehicle is for example done by the entire vehicle being moved to a warehouse, or to another spot, where it is restocked or by a truck or another autonomous vending vehicle restocking it.

The system for example uses a combination of prediction and induction to restock vehicles. If a person in the area of an autonomous vending vehicle normally picks up milk every day, then that milk will be stocked in advance in that vehicle.

Another example of how to predict demand is for the vehicles to stock test products to gauge demand in a certain area and/or demographic.

An example of when the autonomous vehicles are stocked is that the system will re-stock during slow hours, and interchangeably be at various positions. In other words, stocking of an item may be postponed, even if the threshold value has been passed, so that an autonomous vending vehicle does not leave a position of high sales to re-stock an item that is not highly profitable. In this case it must be considered whether the sales income based on the item low in stock is higher than selling other items. Thus, the autonomous vending vehicle can stay at a location to sell other items and indicate that one or more items are out of stock instead of leaving the location to re-stock if this is determined to be more economically beneficial than leaving to re-stock. If possible, while the restocking is done, another autonomous vending vehicle can take the position of the vehicle being re-stocked.

The result of the above is the stocking and routing of autonomous vending vehicles maximising sales per square feet. The calculation may also take into account such matters as probability for a certain purchase, the value of a purchase, the advantages of scales and logistics and the importance of various products for the purchase of other products. The calculations may also take into consideration that certain low value goods might be of a special value to carry, either because they drive traffic, promote goodwill, or make other more expensive products sell.

An example: It has been calculated that a shelf of a certain autonomous vending vehicle shall offer 10 units of Tomato Sauce brand #1, and two units of a more expensive Tomato Sauce brand #2. This is done in conjunction with the fact that Tomato Sauce brand #1 costs less if it is purchased and distributed throughout a whole region. Tomato Sauce brand #2 costs 200% more, which makes its placement economically positive. The vehicle also opens a space for pasta, a low value product, which still adds to the overall positive results by making people more likely to buy the Tomato Sauce, but also provide a necessity for students of the area, driving traffic, and giving goodwill to the store.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed. It should further be noted that any reference signs do not limit the scope of the claims, that the example embodiments may be implemented at least in part by means of both hardware and software.

In the drawings and specification, there have been disclosed exemplary aspects of the disclosure. However, many variations and modifications can be made to these aspects without substantially departing from the principles of the present disclosure. Accordingly, although specific terms are employed, they are used in a generic and descriptive sense only and not for purposes of limitation. The scope of the disclosure being defined by the following claims.

1. A method for controlling stocking of items within an autonomous vending vehicle and routing of the same, comprising:
detecting (S100) removal of at least one item from the vending vehicle;
registering (S110) vending parameters comprising at least type of the removed at least one item and position data of the vending vehicle;
sending (S300) request for a low stock item to a server (30) when the amount of the at least one item is below a predetermined threshold value, wherein the request comprises type of item and position of the vending vehicle; and
receiving (S500) routing and stocking instructions from the server based on the sent request.

2. The method according to claim 1, wherein routing and stocking instructions comprises:
routing instructions to a geographical location to converge with a further autonomous vending vehicle and stocking instructions to receive the at least one item from the further autonomous vending vehicle.

3. The method according to claim 2, wherein the method comprising:
docking (S550) with a further vending vehicle at the geographical location based on the routing and stocking instructions to receive the at least one item.

4. The method according to claim 1, wherein the vending parameters further comprises time data indicating when the at least one item was removed.

5. The method according to claim 1, comprises:
updating (S120) an item list of the vending vehicle based on the at least one removed item.

6. The method according to claim 5, wherein the item list is updated with the vending parameters.

7. The method according to claim 1, wherein the routing and stocking instructions are automated and based on registered vending parameters and current position of the vending vehicle.

8. The method according to claim 1, comprising:
receiving (S410) a request for a specific item from server (30); and
sending (S420) stock information comprising the amount of the requested item within the vending vehicle and position of vending vehicle to server (30).

9. The method according to claim 1, comprising:
receiving pricing instructions, which are based on registered vending parameters and current location of vending vehicle from the server (30); and
updating price of items based on received pricing instructions.

10. The method according to claim 1, comprising:
initiating a transaction of items by registering an entrance (S90) of a customer to the vending vehicle and registering a customer profile, wherein the profile comprises information regarding at least an account for payment; and
detecting (S200) exit of a customer from the vending vehicle and charging the customer account for payment for removal of the at least one item.

11. The method according to claim 1, comprising:
receiving routing instructions based on any one of registered vending parameters, time, date and position parameters of the vending vehicle.

12. The method according to claim 1, comprising:
receiving a request from server to supply a further autonomous vending vehicle with specific item.

13. A method for controlling at least one autonomous vending vehicle comprising:
logging (S1) a demand for specific sales items from customers, wherein the logged demand comprises a sales history of sold items and geographical location information;
routing (S3) the vending vehicle to a geographical location based on the logged demand; and
automatically stocking (S4) the vending vehicle with at least one sales item based on the logged demand.

14. The method according to claim 13, comprises:
calculating (S2) the probability of sales of a specific item at a geographical location based on the logged demand.

15. The method according to claim 13, wherein the stocking (S4) comprises:
routing (S4a) the vending vehicle to a warehouse for receiving at least one sales item.

16. The method according to claim 13, wherein the stocking (S4) comprises:
routing (S4b) the vending vehicle to a further vending vehicle for receiving at least one sales item.

17. An autonomous vending vehicle for controlling stocking of items and routing of the same, comprising a control unit configured to:
detect (S100) removal of at least one item from the vending vehicle;
register (S110) vending parameters comprising at least type of the removed at least one item and position data of the vending vehicle;
send (S300) request for a low stock item to a server (30) when the amount of the at least one item is below a predetermined threshold value, wherein the request comprises type of item and position of the vending vehicle; and
receive (S500) routing and stocking instructions from the server based on the sent request.

18. An autonomous vending vehicle, comprising a control unit configured to:
log (S1) a demand for specific sales items from customers, wherein the logged demand comprises a sales history of sold items and geographical location information;
route (S3) the vending vehicle to a geographical location based on the logged demand; and
automatically stock (S4) the vending vehicle with at least one sales item based on the logged demand.
